(19) United States
(12) Patent Application Publication
(10) Pub. No.: US 2026/0122444 A1
(43) Pub. Date: Apr. 30, 2026

(54) SCENE RECENTERING

(71) Applicant: Bose Corporation, Framingham, MA (US)

(72) Inventors: Thomas Landemaine, Allston, MA (US); Eric R. Bernstein, Cambridge, MA (US); Wade P. Torres, Attleboro, MA (US)

(73) Assignee: Bose Corporation, Framingham, MA (US)

(21) Appl. No.: 19/120,577

(22) PCT Filed: Oct. 12, 2023
(86) PCT No.: PCT/US23/35015

§ 371 Date: Apr. 11, 2025

Related U.S. Application Data
(60) Provisional application No. 63/415,783, filed on Oct. 13, 2022.

(51) Int. Cl. H04S 7/00

(52) U.S. Cl. CPC H04S 7/304; H04S 2400/11

(57) ABSTRACT

Systems, methods, and computer readable media are disclosed that detect a head orientation of a user, determine an anchor position from the detected head orientation, detect a change in the head orientation, and adapt the anchor position to the detected change in head orientation.

### CROSS-REFERENCE TO RELATED APPLICATIONS

This application claims the priority to PCT Application Serial Number PCT/US23/35015, filed on Oct. 12, 2023, entitled “SCENE RECENTERING”, which claims priority to U.S. Provisional Patent Application Ser. No. 63/415,783, filed on Oct. 13, 2022, entitled “SCENE RECENTERING”, the entire contents of which are incorporated herein in their entirety for all purposes.

### BACKGROUND

The term ‘spatialized audio’ may refer to a variety of audio or acoustic experiences, and in some spatialized audio may refer to a simulated experience of one or more virtual, out loud (e.g., loudspeakers), typically delivered to a user or listener via headphones, earbuds, or other suitable wearable audio device. Such a virtualized speaker experience is intended to sound or be perceived by the user as originating at a location in the nearby environment of the user, not form the headphones themselves. For example, conventional stereo listening on headphones can sound as fi the audio is coming from within the user's head, but a stereo spatialized audio experience may sound like there are left and right (virtual) loudspeakers in front of the user. There are numerous techniques for achieving such an experience, at least one of which is disclosed in U.S. patent application Ser. No. 16/592,454 filed Oct. 3, 2019, titled SYSTEMS AND METHODS FOR SOUND SOURCE VIRTUALIZATION, which is published as U.S. Patent Application Publication No. 2020/0037097. There exists a need for various adjustments to the perceived locations of virtual sound sources within spatialized audio systems, methods, and processing.

### SUMMARY

Systems and methods disclosed herein are directed to audio rendering systems, methods, and applications. In particular, systems and methods disclosed are directed to audio systems and methods that produce audio perceived by a user or listener to come from (or be generated at) a virtual location in the area of the user when there may be no real sound source at the virtual location. Various systems and methods herein may produce spatialized sound from multiple virtual locations, such as a virtualized multi-channel surround sound system. Systems and methods herein establish a location, which may be centered in front of the user/listener in some cases, as an anchor position around which the various virtual sound source locations will be established. For example, the location from which a center channel of a multi-channel audio system is to be perceived as originating may be an anchor position, while virtual left and right speakers may be rendered by the audio systems and methods to be perceived as originating from locations to the left and right of the anchor position. Similarly, virtual rear speakers, virtual height channels, virtual object audio sources (e.g., the perceived location of their source moves around the listener, such as by tracking a virtual object), and/or other virtual source and/or reference locations used by various systems and methods may be suitable. In various examples, an anchor position may be any suitable position and may or may not be associated with a particular perceived virtual source location. In some examples, an anchor position may be defined relative to a user of the system or method.

Systems, methods, and computer readable media are disclosed that detect a head orientation of a user, determine an anchor position from the detected head orientation, detect a change in the head orientation, and adapt the anchor position to the detected change in head orientation.

In various examples, the anchor position is slowly adapted when an amount of change of the head orientation is within an angular limit.

In some examples, the anchor position is quickly adapted when the amount of change of the head orientation exceeds the angular limit.

In certain examples, a hold time is imposed when the amount of change of the head orientation exceeds the angular limit, and the anchor position may be quickly adapted if the head orientation exceeds the angular limit beyond the hold time.

Still other aspects, examples, and advantages of these exemplary aspects and examples are discussed in detail below. Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification but are not intended as a definition of the limits of the invention(s). In the figures, identical or nearly identical components illustrated in various figures may be represented by a like reference character or numeral. For purposes of clarity, not every component may be labeled in every figure. In the figures:

FIG. 1 is a schematic view of an example listener scenario;

FIG. 2 is a schematic view of an example spatial audio scenario; and

FIG. 3 is a schematic view of an example spatial audio centering scenario.

### DETAILED DESCRIPTION

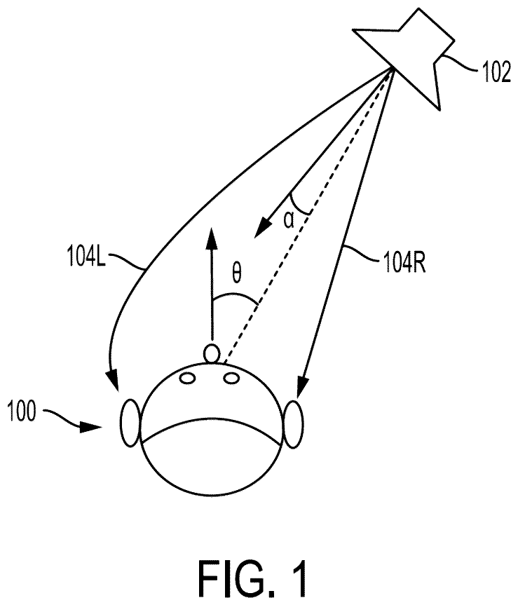

Aspects of the present disclosure are directed to systems and methods ... The term “headphone” as used herein is intended to mean any sound producing device that is configured to provide acoustic energy to each of a user's left and right ears, and to provide some isolation or control over what arrives at each ear without being heard at the opposing ear. Such devices often fit around, on, in, or proximate to a user's ears in order to radiate acoustic energy into the user's ear canal. Headphones may be referred to as earphones, earpieces, earbuds, or ear cups, and can be wired or wireless. Headphones may be integrated into another wearable device, such as a headset, helmet, hat, hood, smart glasses or clothing, etc. The term “headphone” as used herein is also intended to include other form factors capable of providing binaural acoustic energy, such as headrest speakers in an automobile or other vehicle. Further examples include neck-worn devices, eyewear, or other structures, such as may hook around the ear or otherwise configured to be positioned proximate a user's ears. Accordingly, various examples may include open-ear forms as well as over-ear or around-ear forms. A headphone may include an acoustic driver to transduce audio signals to acoustic energy. The acoustic driver may be housed in an ear cup or earbud, or may be open-ear, or may be associated with other structures as described, such as a headrest. A headphone may be a single stand-alone unit or one of a pair of headphones, such as one headphone for each ear. FIG. 1 schematically illustrates a user 100 receiving sound from a sound source 102.

As noted above, head related transfer function (HRTFs) may be calculated or stored in a memory that characterize how the user 100 receives sound from various directions, and are represented by arrows as a left HRTF 104L and a right HRTF 104R (collectively or generally HRTFs 104). The HRTFs 104 are at least partially defined based on an orientation of the user with respect to an arriving acoustic wave emanating from the sound source, indicated by an angle θ. That is, the angle θ represents the relation between the direction that the user 100 is facing with respect to the direction from which the sound arrives (represented by a dashed line). A directionality of the sound produced by the sound source 102 may be defined by a radiation pattern, which varies with the angle α, that represents the relation between the primary (or axial) direction in which the sound source 102 is producing sound and the direction to which the user 100 is located.

Spatialized audio, e.g., which processes audio signals to make sound be perceived as coming from the location of a virtual sound source (e.g., sound source 102) even if nothing is physically producing sound from said location, may be simulated in numerous way. In some examples, one or more HRTFs 104 may be applied with the angle θ. In various examples, directionality of reflections off actual or virtual reflective surfaces (e.g., walls or other objects in a physical or virtual space) may be taken into account. In such examples, virtual reflected sounds will come from differing angles and with differing times of arrivals, each of which may be simulated by additional signal components representative of such reflections. In certain examples, the directionality of the virtual sound source (e.g., sound source 102), which is the radiation pattern of the sound source, may also be taken into account. As recited above, at least one example of a system to spatialize audio into one or more virtual sound sources may be found in in U.S. patent application Ser. No. 16/592,454 filed Oct. 3, 2019, titled SYSTEMS AND METHODS FOR SOUND SOURCE VIRTUALIZATION.

Regardless of various methods of processing audio signals to simulate virtual sound sources, the locations of virtual sound sources should remain relatively fixed as the head of the user 100 moves about. Accordingly, systems and methods herein may use various sensors and methods of detecting the orientation of the user's 100 head, and may account for changes in HRTFs for direct and reflecting angles, and radiation patterns, as appropriate.

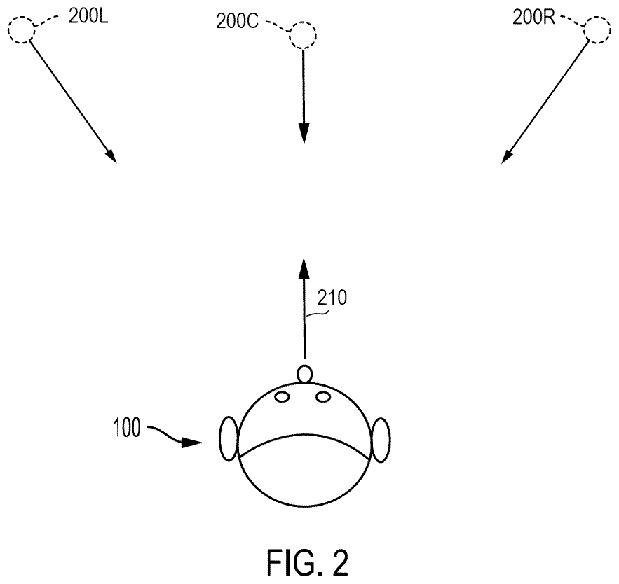

In various examples, however, it may be desirable to adjust the perceived location of virtual sound sources. For example, various systems and methods in accord with those herein may position a virtual sound source directly in front of the user 100 to playback a center channel (or a phantom center channel, such as ‘center’ content not present in the audio source but derived from, e.g., a left-right stereo pair), and may position another virtual sound source to the left of front to playback a left-channel content and to position yet another virtual sound source to the right of front to playback a front-channel content, as illustrated in FIG. 2. Such an arrangement may function well while maintaining the positions of the virtual sound sources, which means adjusting for small movements in the user's head to account for changes in virtual audio directions, e.g., of direct, reflecting, and radiation patterns. However, if the user 100 decides to change position such that he is overall looking a different direction, it may be desirable to have the various positions of the virtual sound sources adjust to the user's new “normal” or front-facing position. For example, if a user is walking and makes a right turn, the front, left, and right channel contents will be perceived as remaining in place, and will now all be on one side of the user rather than in front of the user. Various systems and methods herein make adjustments to the chosen positions of the virtual sound sources to account for the user 100 making a significant and substantially permanent change to the way he is facing, e.g., a look-direction, such as may be contrasted with momentarily looking left or right.

Accordingly, systems and methods herein adjust the location of virtual sound sources in response to a user or listener moving his or her head. Spatialized audio systems and methods virtualize arriving signals such that the user may perceive one or more sounds to come from a fixed location, and such signals must be adjusted as the user moves their head to maintain the perception. Such adjustments due to changing arriving angles (generally discussed above with respect to FIG. 1) are not the adjustments discussed here. Instead, in addition to those perceptual adjustments to maintain virtual sound source position(s), systems and methods in accord with those herein also adjust the virtual sound source position(s) in response to longer term changes in the user's head orientation, e.g., look-direction. According to various examples, one or more virtual sound source positions may be placed or selected (by the system or by user preference) relative to an anchor position, and as the user's head orientation or look-direction changes, the anchor position may adapt to move in accord with the user's look-direction, such that if the user permanently changes the direction he or she is facing, the sound stage of virtual sound sources about him/her will adapt to the new orientation, e.g., a virtual center channel will adjust to remain in front of the user, and other virtual channels will adjust accordingly, in various examples.

Illustrated in FIG. 2 is a user 100 listening to spatialized audio having a virtual left speaker 200L, a virtual right speaker 200R, and a virtual center speaker 200C (collectively, virtual speakers 200). Head orientation of the user 100 may be detected using any number of systems, sensors, and methods, and may be determined or aided by an inertial measurement unit (IMU) in some examples. Accordingly, a look-direction 210 may be determined and the location of the virtual center speaker 200C may be positioned straight in front of the user 100.

As the user's 100 head moves, through normal small changes in orientation, the virtual signals are adjusted to maintain the perceived location of the virtual speakers 200, as discussed above. However, according to various examples, if a user's 100 head orientation changes persist for a bit of time, systems and methods herein may move the positions of the virtual speakers 200 such that they once again re-center in front of the user 100.

In various examples, systems and methods may select an anchor position, to which the positions of the virtual speakers 200 may be relative. In some examples, the anchor position may coincide with the position of the virtual center speaker 200C, but such need not be the case in other examples. Various systems and methods may spatialize additional virtual speaker channels (e.g., rear left, rear right, height channels, etc.) and/or may spatialize additional or other virtual sound sources, such as moving virtual sound sources (e.g., the sound of a motorcycle driving by on the left, or the sound of an airplane flying by overhead, etc.). According to various examples, the positions of each of these sound sources may be characterized relative to a single anchor position, which in systems and methods in accord with those herein, will adjust to a changing orientation of the user 100.

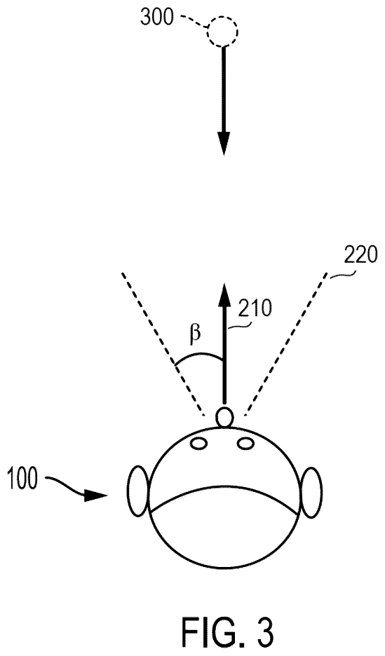

FIG. 3 illustrates an anchor position 300, which in this example is established directly in front of the user 100 and may in some cases align with the location of the virtual center speaker 200C (see FIG. 2), though not necessarily.

According to various examples, as the user's 100 head moves (e.g., a change in orientation of the user's 100 head) the anchor position 300 is slowly adjusted to move to being re-centered in front of the user 100. In certain examples, a slow adjustment may mean the anchor position 300 may take about 3 seconds to move, though other timeframes and/or time constants are contemplated herein.

For example, consider that the user 100 is looking at a computer display and the virtual sound stage is centered on the computer display (e.g., virtual center channel right in front, left and right virtual channels to the left and right, respectively), then the user 100 turns his or her head (e.g., by about 10 degrees, for example) to look at an adjacent display. Systems and methods herein adjust the anchor position 300 in response, and after about 3 seconds the virtual sound stage will once again be in front of the user 100, centered on the adjacent display. In this manner, if the user 100 only briefly looks over to the adjacent display then looks back, the anchor position 300 will have only briefly started to adjust but then re-adjusts to remain centered on the initial computer display. The user 100 may not even perceive the moving virtual sound stage in this instance.

Consider now that there is a further display, such as on an adjacent wall, that requires the user 100 to turn his or her head 90 degrees. If the user 100 only briefly looks at the further display, it may be desirable to not adjust the anchor position 300 at all. If the user 100 is turning to look at the further display for an extended time, however, it may be desirable to adjust the anchor position 300 more quickly (e.g., to more quickly re-center the virtual sound stage in front of the user 100). Indeed, the user 100 may have turned his or her entire body, such as swiveling in an office chair, to look at the further display for an extended period.

Accordingly, an angle β on either side of the user's 100 look-direction defines a boundary 220 of an angular limit which defines a range of head orientations in which the systems and methods herein may slowly adapt the anchor position 300.

According to various examples, the angle β that defines the boundary 220 may be less than or equal to 40 degrees. In certain examples, the angular limit may be defined by an angle β of approximately 30 degrees, 20 degrees, 10 degrees, or 5 degrees. Other angular limits may apply to various systems and methods.

If the user's 100 head orientation goes outside of the angular limit, various examples herein do not slowly adapt the anchor position 300. They may adapt more rapidly, or they may freeze adaptation for a hold time, such as to ‘confirm’ that the large change is more permanent, and then adapt more quickly (e.g., more rapidly than the slow adaptation).

When the anchor position 300 is rapidly adapted, it is more quickly adjusted to re-center the virtual sound stage in front of the user 100. In certain examples, a quick adjustment may mean the anchor position 300 may take only about 1 second to move, though other timeframes and/or time constants are contemplated herein.

In some examples, a hold time may be imposed upon adapting the anchor position 300 when the user's 100 head orientation goes outside the angular limit. During the hold time, the anchor position 300 may not be adapted at all and may instead remain fixed in place. In certain examples, the hold time may be about 3 seconds.

In various examples, the angular limit may define a wedge or pie-shaped range of positions in a two-dimensional plane, e.g., defined with respect to gravity or up/down. In other words, certain systems and methods herein may be concerned only with head rotations left and right and not with looking up or down. In other examples, systems and methods may adapt to all changes in head orientation, and thus the angular limit may define a cone.

Examples of the methods and apparatuses discussed herein are not limited in application to the details of construction and the arrangement of components set forth in the above descriptions or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Also, the phraseology and terminology used herein is for the purpose of description and should not be regarded as limiting. Any references to examples, components, elements, acts, or functions of the systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation, unless the context reasonably implies otherwise.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A method for adapting an anchor position for relative locations of one or more virtual loudspeakers, the method comprising:
detecting a head orientation of a user;
determining the anchor position from the detected head orientation;
detecting a change in the head orientation; and
slowly adapting the anchor position to the detected change in head orientation when an amount of change of the head orientation is within an angular limit.

2. The method of claim 1 wherein the angular limit is less than or equal to one of 40 degrees, 30 degrees, 20 degrees, 10 degrees, and 5 degrees from a previous head orientation.

3. The method of claim 1 wherein slowly adapting the anchor position to the detected change in head orientation includes adjusting the anchor position to the detected head orientation on a time scale of about three seconds.

4. The method of claim 1 further comprising freezing the anchor position when the amount of change in head orientation exceeds the angular limit.

5. The method of claim 4 further comprising quickly adapting the anchor position to the head orientation when the amount of change of the head orientation exceeds the angular limit for a duration in excess of an amount of time.

6. The method of claim 5 wherein the amount of time is three seconds or greater.

7. The method of claim 5 wherein quickly adapting the anchor position to the head orientation includes adjusting the anchor position to the detected head orientation on a time scale of about one second.

8. An apparatus comprising:
an acoustic transducer;
an inertial measurement unit (IMU); and
a processor coupled to the acoustic transducer, the processor configured to perform the method of claim 1.

9. A non-transitory computer readable medium having instructions encoded thereon that, when executed by a processor, cause the processor to perform the method of claim 1.
